(19) United States
(12) Patent Application Publication
(10) Pub. No.: US 2021/0398176 A1
(43) Pub. Date: Dec. 23, 2021

(54) APPARATUS, METHOD, AND STORAGE MEDIUM FOR BURSTABLE INSTANCE RECOMMENDATION

(71) Applicant: Hitachi, Ltd., Tokyo (JP)

(72) Inventors: Satishkumar JAISWAL, Tokyo (JP); Satoshi KANEKO, Tokyo (JP); Katsunori SUZUKI, Tokyo (JP); Shinichi HAYASHI, Tokyo (JP)

(21) Appl. No.: 17/192,025

(22) Filed: Mar. 4, 2021

(30) Foreign Application Priority Data
Jun. 17, 2020 (JP) 2020-104878

(51) Int. Cl. G06Q 30/02; G06Q 10/06

(52) U.S. Cl. CPC G06Q 30/0283; G06Q 10/06315

(57) ABSTRACT

In a burstable instance recommendation server including a processor, and providing information on a burstable instance provided by a public cloud, the burstable instance being a candidate to which a predetermined instance under utilization is migrated, the processor identifies a first candidate burstable instance provided by the public cloud based on performance time series data of the instance under utilization. The processor calculates high load performance time series data in which occurrence of a load higher than in the performance time series data is estimated on the identified first candidate burstable instance, and the processor calculates a penalty in case of the high load performance time series data. The processor recognizably displays a cost of the first candidate burstable instance and the penalty.

### CROSS-REFERENCE TO RELATED APPLICATION

The present application claims priority from Japanese application JP 2020-104878, filed on Jun. 17, 2020, the contents of which is hereby incorporated by reference into this application.

### BACKGROUND

The present invention relates to a technique of recommending a burstable instance.

Among works executed in computers, there is known a work having characteristics in which the resource utilization ratio of resources of a processor, for example, is low for most of time and the resource utilization ratio increases from time to time. A temporary increase in a resource demand is known as a “burst”.

In regard to such a burst, there is known a technique that meets problems of scaling up resources in the burst by utilizing resources in a cloud, for example, not utilizing resources in on-premises (e.g. see U.S. Pat. No. 9,606,826). U.S. Pat. No. 9,606,826 provides a system, a method, and a computer program for selecting virtual machines to be migrated to a public cloud during bursting based on resource usage and scaling policies.

The venders of public clouds provide instances that can be burst (burstable instances) as instances of a virtual machine (VM). The burstable instance only guarantees only a part of CPU usage rates at much lower cost, and the settings of criteria or prices in the case of occurrence of a burst are sometimes managed using CPU credits.

### SUMMARY

Conventionally, there is no recommendation of appropriately utilizing burstable instances. Price models according to the CPU credits of burstable instances are complicated, and the price models are varied among the venders of public clouds providing burstable instances, resulting in further increasing complications.

There is a request for recommending effective burstable instances in future.

The present invention has been made under the circumstances. An object is to provide a technique that can appropriately recommend a burstable instance to be a candidate to which an instance is migrated.

In order to achieve the object, a burstable instance recommendation apparatus according to an aspect includes a processor, the burstable instance recommendation apparatus providing information on a burstable instance provided by a public cloud, the burstable instance being a candidate to which a predetermined instance under utilization is migrated. The processor identifies a first candidate burstable instance provided by the public cloud, the first candidate burstable instance to which the instance under utilization is migratable based on performance time series data of the instance under utilization. The processor calculates high load performance time series data in which occurrence of a load higher than in the performance time series data is estimated on the identified first candidate burstable instance. The processor calculates a penalty in case of the high load performance time series data. The processor recognizably displays a cost of the first candidate burstable instance and the penalty.

According to the present invention, a burstable instance to be a candidate to which an instance is migrated can be appropriately recommended.

### BRIEF DESCRIPTION OF THE DRAWINGS

FIG. 1 is an overall block diagram of a computer system according to an embodiment;

FIG. 2 is a block diagram of a burstable instance recommendation server according to an embodiment;

FIG. 3 is a block diagram of an instance configuration data table according to an embodiment;

FIG. 4 is a block diagram of a CPU usage rate time series data table according to an embodiment;

FIG. 5 is a block diagram of an instance configuration and price data table according to an embodiment;

FIG. 6 is a flowchart of a burstable instance recommendation process according to an embodiment;

FIG. 7 is a diagram illustrating CPU usage rate history time series data and prediction time series data according to an embodiment;

FIG. 8 is a flowchart of a burstable instance identification process according to an embodiment;

FIG. 9 is a diagram showing an example burstable instance recommendation screen according to an embodiment;

FIG. 10 is a diagram illustrating the management of a CPU credit according to an embodiment;

FIG. 11A is a diagram illustrating examples of a change in the CPU usage rate and a change in the CPU credit balance according to an embodiment; and

FIG. 11B is a diagram illustrating an example calculation method for performance penalties according to an embodiment.

### DETAILED DESCRIPTION

An embodiment will be described with reference to the drawings. Note that an embodiment described below is not limited to the invention in claims, and all components and all combinations of the components described in the embodiment do not necessarily have to be needed for the solutions for the invention.

In the following description, information will be described in the expression “AAA Table”. However, information may be expressed in any data structure. That is, in order to show that information does not depend on any data structure, “AAA Table” can be referred to as “AAA information”.

In the following description, processes are sometimes described as “programs” are operation subjects. However, since the program is executed by a processor to perform a predetermined process appropriately using at least one of a storage unit or an interface part, the subject of the process may be a processor (or a computer or a computer system having a processor). The program may be installed from a program source to a computer. The program source may be a program distribution server-readable storage medium or a computer-readable storage medium, for example, (e.g. portable storage medium). In the following description, two or more programs may be implemented as one program, or one program may be implemented as two or more programs. At least a part of processes implemented by a hardware circuit (e.g. ASIC (Application Specific Integrated Circuit) or FPGA (Field-Programmable Gate Array)).

In an embodiment, a candidate is selected for one or more suited inexpensive burstable instances in a public cloud, the burstable instances to which instances in on-premises (on-premise instances) constituting a VM are migrated. The selection of a candidate for a burstable instance is based on the prediction of the time series data of a CPU usage rate of an on-premise instance. In the present embodiment, costs and penalties occurring a burstable instance to be a migration destination are visualized.

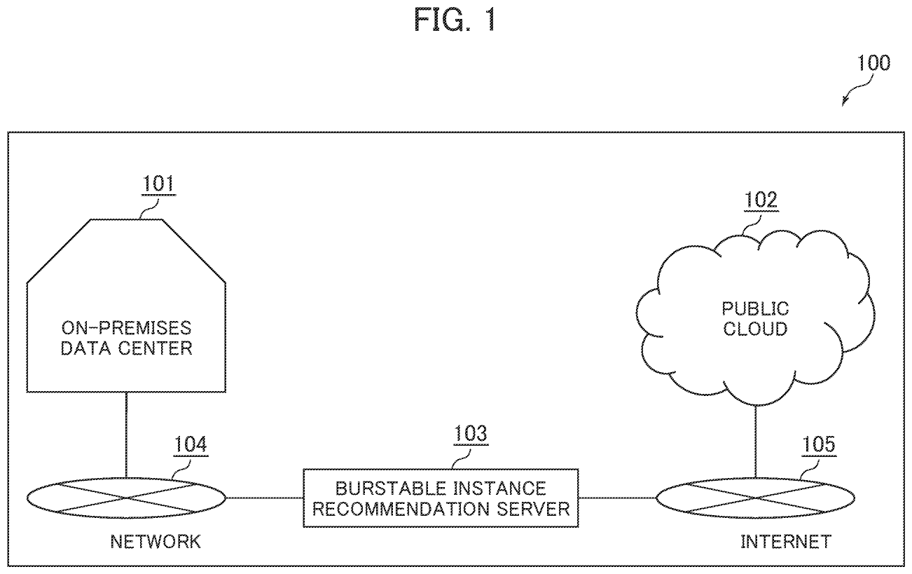

FIG. 1 is an overall block diagram of the computer system according to an embodiment.

A computer system 100 includes one or more on-premise data centers 101, a burstable instance recommendation server 103 as an example of a burstable instance recommendation apparatus, and a public cloud 102.

The on-premise data center 101 is connected to the burstable instance recommendation server 103 via a network 104. The network 104 is a cable LAN (Local Area Network), wireless LAN, or any other LAN, for example. The burstable instance recommendation server 103 is connected to the public cloud 102 via an Internet 105.

The on-premise data center 101 provides an instance (on-premise instance) constituting a VM. The public cloud 102 can provide an instance constituting a VM. The instances that can be provided by the public cloud 102 include instances (fixed performance instances) that can provide fixed performances as the usage rate of the CPU, and burstable instances usable by bursting base lines when the criteria (the base lines) of the usage rate of the CPU are set and a predetermined condition is satisfied (e.g. the balance of a CPU credit, described later, is available). Such burstable instances have a standard mode in which performances are limited not to exceed a base line as a penalty in the case in which a predetermined conditions is not satisfied (in the case in which there is no balance of the CPU credit) and an unlimited mode in which no limitations are imposed on performances even in the case in which a predetermined condition is not satisfied (in the case in which there is no balance of the CPU credit) and additional costs occur as a penalty.

Next, the burstable instance recommendation server 103 will be described in detail.

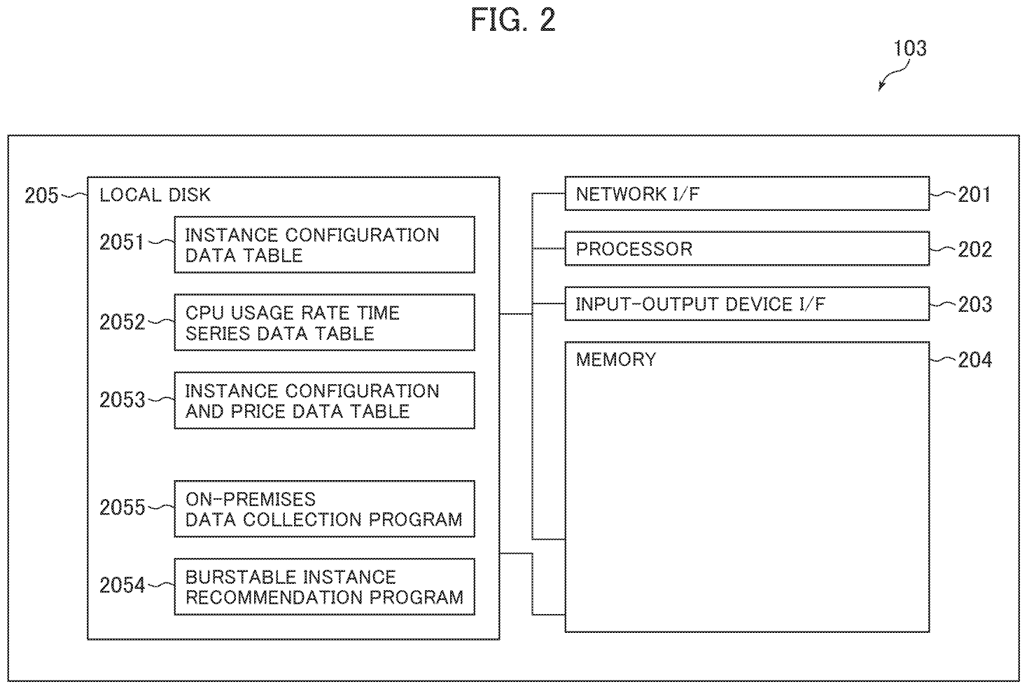

FIG. 2 is a block diagram of the burstable instance recommendation server according to an embodiment.

The burstable instance recommendation server 103 is configured from a typical computer, for example, and includes a network interface (a network I/F) 201, a processor 202, an input-output device interface (an input-output device I/F) 203, a memory 204, and a local disk 205.

The network I/F 201 is an interface for a cable LAN card, wireless LAN card, and any other cards, for example, and communicates with other devices (e.g. devices of the on-premise data center 101 or the public cloud 102) via the network 104 and the Internet 105.

The processor 202 executes various processes according to programs stored on the memory 204 and/or the local disk 205.

The input-output device I/F 203 is an interface connecting input devices including a touch panel, a display, a keyboard, and a mouse, for example, or output devices.

The memory 204 includes a RAM (RANDOM ACCESS MEMORY), for example, and memorizes programs executed on the processor 202 or necessary information.

The local disk 205 is an HDD (hard disk drive), an SSD (solid-state drive), and any other device, for example, and memorizes programs executed on the processor 202 or data utilized on the processor 202. In the present embodiment, the local disk 205 memorizes an on-premise data collection program 2055 and a burstable instance recommendation program 2054 as programs, and memorizes an instance configuration data table 2051, a CPU usage rate time series data table 2052, and an instance configuration and price data table 2053 as data.

The burstable instance recommendation program 2054 is executed by the processor 202, and performs a process of recommending a burstable instance in the public cloud 102 to which an on-premise instance (an example of an instance under utilization) used in the on-premise data center 101 is moved.

The on-premise data collection program 2055 is executed by the processor 202, collects the configuration data of the on-premise instance from the on-premise data center 101, stores the configuration data on the instance configuration data table 2051, collects the time series data of the CPU usage rate (performance time series data), and registers the time series data on the CPU usage rate time series data table 2052. The information stored on the instance configuration data table 2051 and on the CPU usage rate time series data table 2052 can be collected using an API (Application Programming Interface) provided by the cloud computing platform of the public cloud 102, for example. Note that a method of collecting information is not limited to this.

Next, the instance configuration data table 2051 will be described.

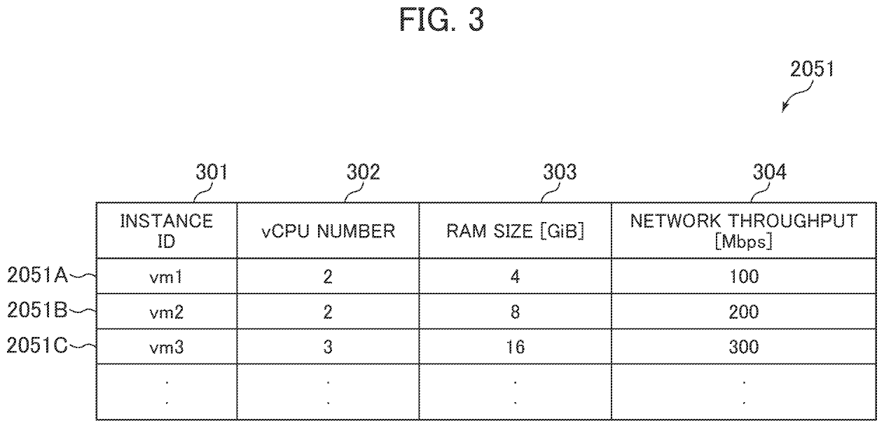

FIG. 3 is a block diagram of the instance configuration data table according to an embodiment.

The instance configuration data table 2051 stores a row (a record) for every on-premise instance to be a target (a consideration target) to which migration is considered in the on-premise data center 101. The instance configuration data table 2051 has records in the same number as the number of on-premise instances to which migration is considered. The records each include columns of an instance ID 301, a virtual CPU number (vCPU number) 302, a RAM size 303, and a network throughput 304.

The instance ID 301 is an ID identifying an on-premise instance corresponding to the record, and used as a key connecting to other relating tables (e.g. the CPU usage rate time series data table 2052 and any other tables). The other columns are setting parameters for the on-premise instance corresponding to the record. The vCPU number 302 expresses the number of the vCPUs allocated to the on-premise instance corresponding to the record. The RAM size 303 expresses the size of the RAM allocated to the on-premise instance corresponding to the record. The size of the RAM has a unit of GiB, for example. The network throughput 304 expresses a network throughput allocated to the on-premise instance corresponding to the record. The network throughput has a unit of Mbps, for example. Note that the setting parameters for the on-premise instance in the record are not limited to the setting parameters described above. The other setting parameters including the size of a primary storage device, the storage I/O, and any other parameter, for example, may be included, as necessary.

For example, a record 2051A expresses that an on-premise instance having instance ID vm1 has two vCPUs, a four-GiB RAM, and a 100-Mbps network throughput.

Next, the CPU usage rate time series data table 2052 will be described.

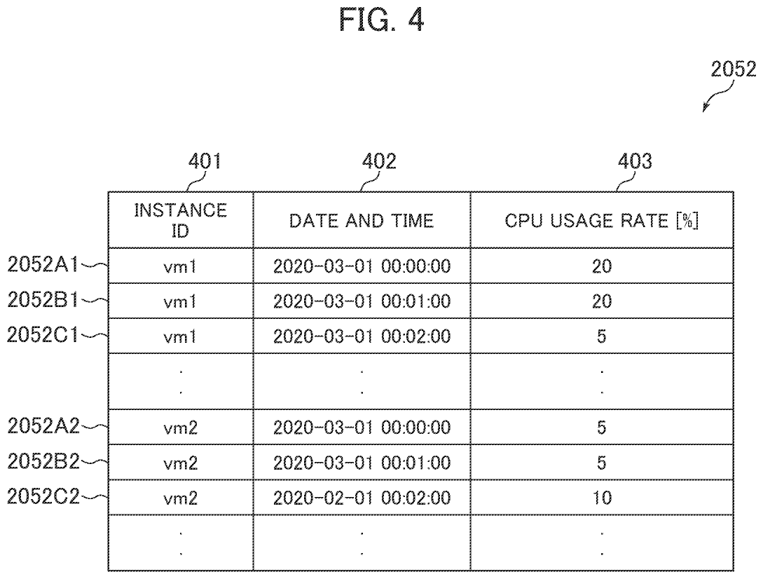

FIG. 4 is a block diagram of the CPU usage rate time series data table according to an embodiment.

The CPU usage rate time series data table 2052 stores the time series data of the CPU utilization ratio of each of the on-premise instances, and stores the records at points in time in the on-premise instances. In the CPU usage rate time series data table 2052, there are records in the number in which the number of records of one on-premise instance is multiplied by the total number of on-premise instances regarded as a consideration target for migration.

The records on the CPU usage rate time series data table 2052 include the columns of an instance ID 401, a date and time 402, and a CPU usage rate 403.

The instance ID 401 is an ID identifying an on-premise instance corresponding to the record, and used as a key connecting other relating tables (e.g. the instance configuration data table 2051 and any other tables). The date and time 402 expresses the date and time of information corresponding to the record. The CPU usage rate 403 expresses a CPU usage rate (e.g. %) in the on-premise instance corresponding to the record. Here, the CPU usage rate is the average CPU usage rate of all usable vCPUs in the on-premise instance. for example, the on-premise instance has two vCPUs, and in the case in which the CPU usage rate is 20%, this means that the usage rate of one CPU is 2×20=40%.

For example, the record 2052A1 expresses that the CPU usage rate on date and time 2020-03-01 00:00:00 in the on-premise instance having instance ID vm1 is 20%.

Here, the number of records corresponding to a single on-premise instance depends on (i) a grain size and (ii) a data retaining policy. In the present embodiment, for example, the grain size is one minute and a policy retains data for 90 days. However, other settings may be provided based on the nature and availability of data.

Next, the instance configuration and price data table 2053 will be described.

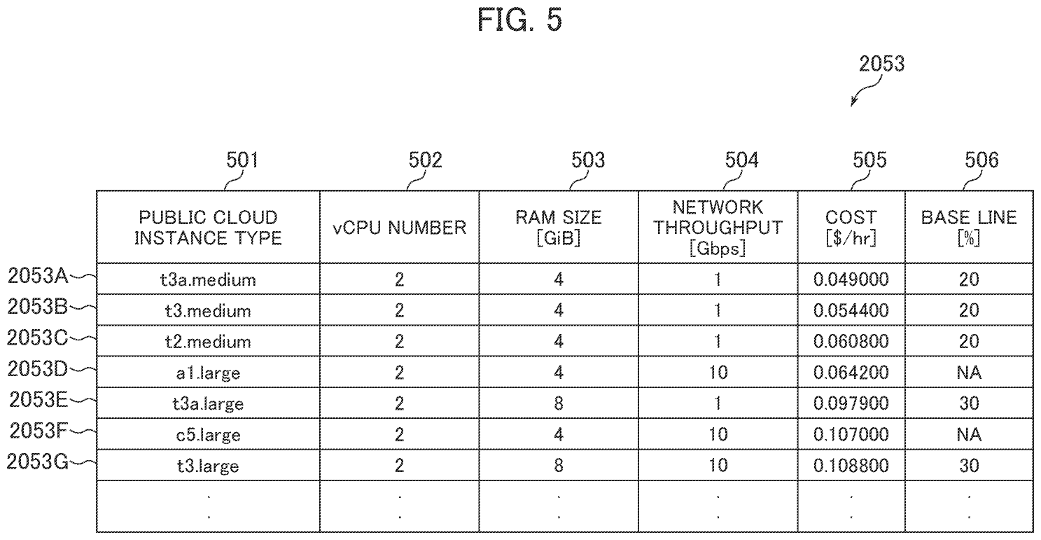

FIG. 5 is a block diagram of the instance configuration and price data table according to an embodiment.

The instance configuration and price data table 2053 stores the configuration and price data of an instance (a public cloud instance) provided by the public cloud 102, and stores records of each of public cloud instances.

The record of the instance configuration and price data table 2053 includes the columns of a public cloud instance type 501, a vCPU number 502, a RAM size 503, a network throughput 504, a cost 505, and a base line 506.

The public cloud instance type 501 is a name of the public cloud instance corresponding to the record. The vCPU number 502 expresses the number of the vCPUs allocated to the public cloud instance corresponding to the record. The RAM size 503 expresses the size of the RAM allocated to the public cloud instance corresponding to the record. The size of the RAM has a unit of GiB, for example. The network throughput 504 expresses a network throughput allocated to the public cloud instance corresponding to the record. The network throughput has a unit of Gbps, for example. The columns 502 to 504 are setting parameters of the public cloud instance corresponding to the record. Note that the setting parameters of the public cloud instance in the record are not limited to the parameters described above. The other setting parameters including the size of a primary storage device, the storage I/O, and any other parameter, for example, may be included, as necessary.

The cost 505 is a cost per hour for the public cloud instance corresponding to the record. The cost has a unit of $/hr, for example. The base line 506 expresses a criterion (a base line) of the CPU usage rate per vCPU in the case in which the public cloud instance is a burstable instance. Note that in the case in which the public cloud instance corresponding to the record is not a burstable instance, i.e., in the case of a fixed performance instance, the base line 506 is set to “NA”.

For example, the record 2053A expresses that a public cloud instance having name t3a.medium has two vCPUs, a four-GiB RAM, and one-Gbps network throughput. This public cloud instance costs 0.049000 $/hr, a 20%-base line, i.e., expressing that the overall base line is 2×20=40%.

Similarly, the record 2053D expresses that a public cloud instance having name a1.large has two vCPUs, a four-GiB RAM, and a ten-Gbps network throughput. This public cloud instance costs 0.0642000 $/hr, expressing that this public cloud instance is a fixed performance instance.

Next, the operation of processes by the burstable instance recommendation server 103 will be described.

First, a burstable instance recommendation process will be described.

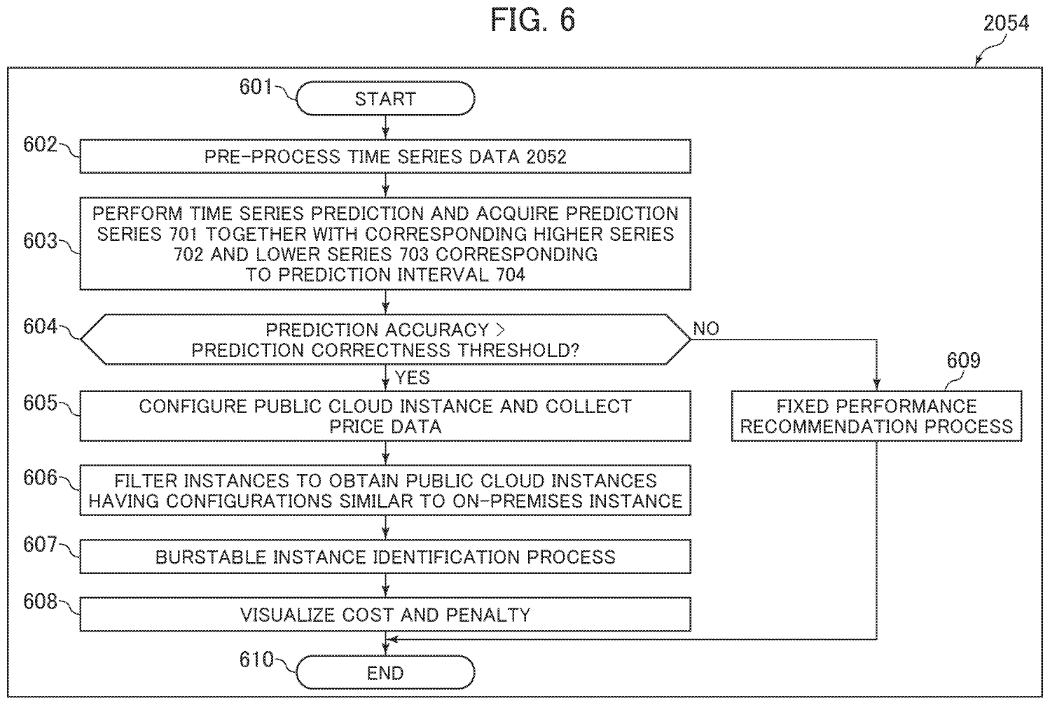

FIG. 6 is a flowchart of a burstable instance recommendation process according to an embodiment.

The burstable instance recommendation process is executed by the processor 202 executing the burstable instance recommendation program 2054 as on-premise instances to be consideration targets for migration are targeted. In the description of the process, an on-premise instance to be a target for processing is referred to as a target on-premise instance.

The burstable instance recommendation program 2054 (specifically, the processor 202 executing the burstable instance recommendation program 2054) executes a predetermined pre-process to time series data (history time series data) of a target on-premise instance on the CPU usage rate time series data table 2052 (Step 602). As the pre-process, various pre-processes can be performed depending on time series data. In the present embodiment, a pre-process of unifying CPU utilization ratios due to differences in the sizes of VMs, for example. Since the number of the vCPUs equipped in instances constituting the VM is varied, the values of the CPU usage rate 403 on the CPU usage rate time series data table 2052 are not utilized as they are. Therefore, scaling is performed to obtain a unified CPU usage rate in values between the number of the vCPUs and the CPU usage rate 403. As examples of scaling methods, various methods such as linear scaling can be used. Specifically, in the case in which the CPU usage rate of an having four vCPUs is 20%, the CPU usage rate of two vCPUs is 40%. Note that the pre-process is not limited to the method above. for example, a process of complementing data may be performed for a time period of shortage as time series data on the CPU usage rate time series data table 2052.

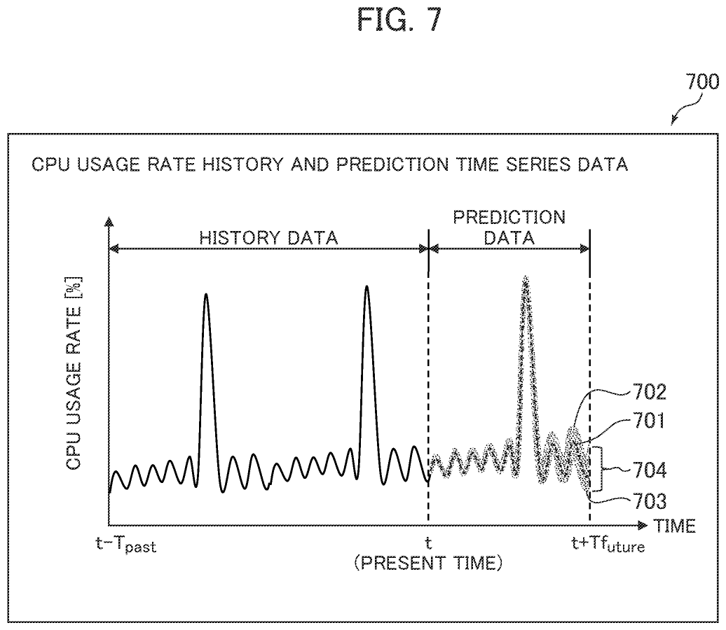

Subsequently, the burstable instance recommendation program 2054 predicts future time series data of the CPU usage rate (prediction performance time series data) on the target on-premise instance based on history time series data (Step 603). As a method of predicting future time series data from history time series data, a given time series prediction algorithm or a given prediction model can be used. In the present embodiment, for example, a fine tuned SARIMA model (a prediction model) is created to predict time series data. In the present embodiment, the burstable instance recommendation program 2054 generates prediction time series data (a prediction series 701, see FIG. 7) predicted from history time series data and prediction time series data (a higher series 702: high load performance time series data) on the side where the CPU usage rate is increased in consideration of an increase or a decrease in the CPU usage rate and a fluctuation width (a prediction interval 704) to the prediction series 701, and prediction time series data (a lower series 703) on the side where the CPU usage rate is decreased. Note that the prediction series 701, the higher series 702, the lower series 703, and the prediction interval 704 will be described later with reference to FIG. 7.

Subsequently, the burstable instance recommendation program 2054 identifies the prediction accuracy of the prediction model predicting the prediction series 701, and determines whether the prediction accuracy is larger than a predetermined threshold (a prediction correctness threshold) (Step 604).

Here, as a metric for measuring the prediction accuracy of the prediction model predicting the prediction series 701, various metrics can be used. However, an average absolute error, for example, may be used. for example, a configuration may be provided in which data at a predetermined rate (e.g. 66%) in history time series data is used for learning and a prediction model is evaluated using the remaining data.

As a result, in the case in which the prediction accuracy is not larger than a predetermined threshold (Step 604: No), this case shows that the accuracy of calculating the cost or penalty of the burstable instance using the prediction series 701, for example, is low. Thus, the burstable instance recommendation program 2054 executes a fixed performance recommendation process of recommending a fixed performance instance as a migration candidate for the target on-premise instance (Step 609), and ends the process. Here, in the fixed performance recommendation process, the burstable instance recommendation program 2054 identifies a fixed performance instance including the configuration of the target on-premise instance, and recommends the identified fixed performance instance as a migration candidate.

On the other hand, in the case in which the prediction accuracy is later than a predetermined threshold (Step 604: Yes), the case shows that the accuracy of calculating the cost or penalty of the burstable instance using the prediction series 701, for example, is high and recommendation is effective. Thus, the burstable instance recommendation program 2054 collects the settings and price data of the public cloud instance from the public cloud 102, and registers the settings and the price data on the instance configuration and price data table 2053 (Step 605). Here, as a method of collecting the settings and price data of the public cloud instance from the public cloud 102, APIs provided by public cloud venders providing the public cloud 102 may be used. Note that the settings and price data of the public cloud instance are collected at this point in time, and thus a burstable instance can be recommended using the latest data of the public cloud instance.

Subsequently, the burstable instance recommendation program 2054 filters the selection of a public cloud instance having a configuration including the configuration of the target on-premise instance to the instance configuration and price data table 2053 (Step 606). Note that the list of records of the public cloud instance selected by this process is referred to as a candidate list.

Here, for example, in the case in which the target on-premise instance is an instance having instance ID vm1 corresponding to the record 2051A on the instance configuration data table 2051, filtering is performed such that target on-premise instances are only public cloud instances having a configuration including the configuration having two vCPUs, the size of a four-GiB RAM, and a 100-Mbps network throughput. by this filtering, a candidate list of public cloud instances corresponding to records 2053A, 2053B, 2053C, 2053D, and 2053F is obtained as the public cloud instances to be candidates to which the target on-premise instance can be migrated. In these public cloud instances, public cloud instances corresponding to the records 2053A, 2053B, and 2053C are burstable instance, and public cloud instances corresponding to the records 2053D and 2053F are fixed performance instances. Note that only burstable instances may be filtered by this process.

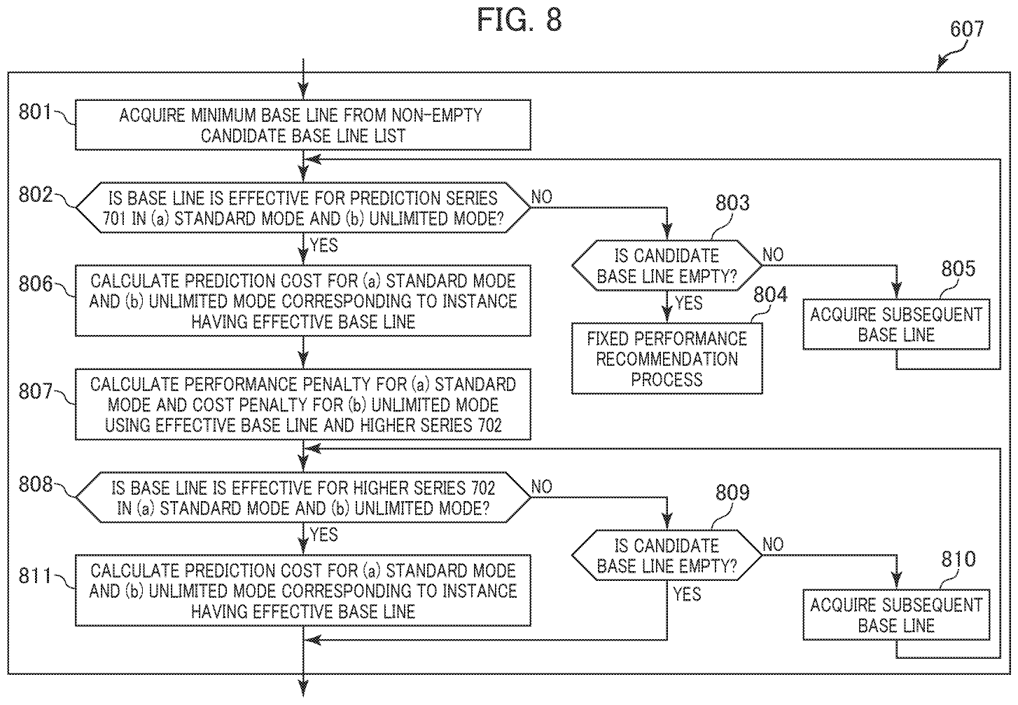

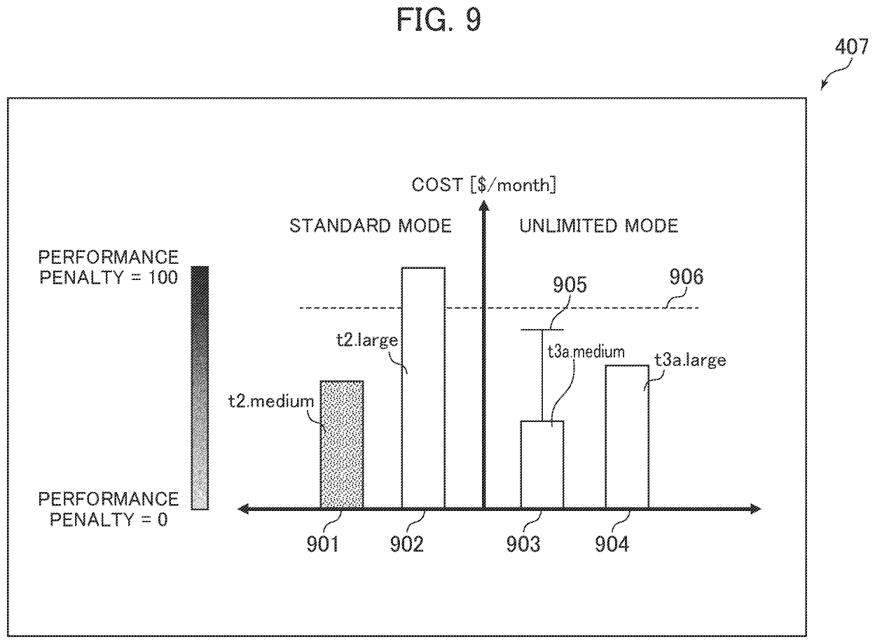

Subsequently, the burstable instance recommendation program 2054 executes a burstable instance identification process (see FIG. 8) of calculating a cost or a penalty of one or more burstable instances suited to migration from the candidate list (Step 607), and displays a screen visualizing a cost or a penalty of the burstable instance identified by the burstable instance identification process, i.e., a screen including a cost or a penalty of the burstable instance (e.g. a burstable instance recommendation screen 407 in FIG. 9) (Step 608).

Here, CPU usage rate history time series data and prediction time series data will be described.

FIG. 7 is a diagram illustrating CPU usage rate history time series data and prediction time series data according to an embodiment. FIG. 7 shows the history and prediction of the time series data of the CPU usage rate on the on-premise instance having instance ID vm1, for example.

The history time series data (history data) in a graph 700 is obtained from the record corresponding to the on-premise instance on the CPU usage rate time series data table 2052. On the other hand, the prediction time series data (prediction data) is obtained from a prediction model generated based on the history data. In FIG. 7, a keeping period Tₚₐₛₜ of the history data is 90 days, and a prediction period T_{future} of the prediction data is 30 days. Note that the keeping days and the prediction period are not limited to these period.

Here, the prediction series 701 is prediction data outputted from the prediction model. The prediction interval 704 is an interval including actual data at a predetermined probability (e.g. 95%), for example. The higher series 702 is time series data on the upper side, i.e., the high load side of the prediction interval 704. The lower series 703 is time series data on the lower side of, i.e., the low load side of the prediction interval 704. In the present embodiment, the burstable instance recommendation program 2054 determines the prediction series 701 based on the history time series data, further calculates the prediction interval 704, and the higher series 702 and the lower series 703.

Next, the burstable instance identification process (Step 607) will be described in detail.

FIG. 8 is a flowchart of the burstable instance identification process according to an embodiment.

The burstable instance recommendation program 2054 creates a list (a candidate base line list) only including the base lines of the public cloud instances on (a) standard mode and (b) unlimited mode from a candidate base line list, and acquires a minimum base line (referred to as a target base line) on (a) standard mode and a minimum base line on (b) unlimited mode (Step 801).

Subsequently, the burstable instance recommendation program 2054 determines whether the target base line is effective to the prediction series 701, i.e., whether no penalty occurs within the range of the prediction series 701 on (a) standard mode and (b) unlimited mode (Step 802).

As a result, in the case in which the base line is ineffective to the prediction series 701 (Step 802: No), the burstable instance recommendation program 2054 determines whether the candidate base line list corresponding to the mode is empty (Step 803). As a result, in the case in which the candidate base line list corresponding to the mode is empty (Step 803: Yes), this case means that no burstable instance to be a recommendation target is present, and the burstable instance recommendation program 2054 executes the fixed performance recommendation process of recommending a fixed performance instance (Step 804). This fixed performance recommendation process is a process similar to Step 609.

On the other hand, in the case in which the candidate base line list corresponding to the mode is not empty (Step 803: No), the burstable instance recommendation program 2054 acquires a second smallest base line from the candidate base line list as a target base line (Step 805), advances the process to Step 802, and performs a similar process.

On the other hand, in the case in which the base line is effective to the prediction series 701 (Step 802: Yes), the burstable instance recommendation program 2054 calculates a prediction cost on the burstable instance (a first candidate burstable instance) in each of the modes corresponding to the base line determined as effective. Here, the prediction cost can be calculated based on the cost acquired from the cost 505 on the record of the public cloud instance corresponding to the target base line determined as effective.

Subsequently, the burstable instance recommendation program 2054 calculates a penalty on the burstable instance in each of the modes corresponding to the target base line determined as effective in Step 802, using the target base line determined as effective in Step 802 and the higher series 702 (Step 807). for example, in the case in which the target base line of the burstable instance in the standard mode is determined as effective in Step 802, the performance penalty in the burstable instance in the standard mode is calculated, whereas in the case in which the target base line of the burstable instance in unlimited mode is determined as effective in Step 802, the cost penalty in the burstable instance in the unlimited mode is calculated. According to this process, a penalty in the case in which the CPU usage rate of the burstable instance is a high load like the higher series 702 can be appropriately predicted.

Subsequently, the burstable instance recommendation program 2054 determines whether the target base line is effective to the higher series 702, i.e., whether no penalty occurs within the range of the higher series 702 to (a) standard mode and (b) unlimited mode (Step 808).

As a result, in the case in which the base line is not ineffective to the higher series 702 (Step 808: No), the burstable instance recommendation program 2054 determines whether the candidate base line list corresponding to the mode is empty (Step 809). As a result, in the case in which the candidate base line list corresponding to the mode is empty (Step 809: Yes), this case means that there is no other burstable instance to be recommended, and the burstable instance recommendation program 2054 ends the process.

On the other hand, in the case in which the candidate base line list corresponding to the mode is not empty (Step 809: No), the burstable instance recommendation program 2054 acquires a second smallest base line as a target base line from the candidate base line list (Step 810), advances the process to Step 808, and performs a similar process.

On the other hand, in the case in which the base line is effective to the higher series 702 (Step 808: Yes), the burstable instance recommendation program 2054 calculates a prediction cost of the burstable instance in each of the modes (the second candidate burstable instance) corresponding to the base line determined as effective, and ends the process. Here, the prediction cost can be calculated based on the public cloud instance corresponding to the target base line determined as effective and the cost acquired from the cost 505 in the record of the instance configuration and price data table 2053.

According to the burstable instance identification process, four burstable instances are identified, for example, the burstable instance effective to the prediction series 701 and having the smallest base line in the standard mode, the burstable instance effective to the higher series 702 and having the smallest base line in the standard mode, the burstable instance effective to the prediction series 701 and having the smallest base line in the unlimited mode, and the burstable instance effective to the higher series 702 and having the smallest base line in the unlimited mode.

Next, the burstable instance recommendation screen 407 will be described in detail.

FIG. 9 is a diagram showing an example burstable instance recommendation screen according to an embodiment.

The burstable instance recommendation screen is a screen displaying information on a candidate burstable instance recommended as a migration destination to an on-premise instance that is one migration target. The burstable instance recommendation screen displays a box expressing a candidate burstable instance to be recommended. In the boxes, the name of a corresponding burstable instance is displayed. In the boxes, the vertical length expresses the normal cost of the burstable instance.

In the burstable instance recommendation screen 407 shown in FIG. 9, boxes 901, 902, 903, and 904 expressing four burstable instances are displayed. Two boxes 901 and 902 on the left side of the screen are boxes expressing burstable instances in the standard mode, and two boxes 903 and 904 on the right side of the screen are boxes expressing burstable instances in the unlimited mode.

The box 901 is a box corresponding to the burstable instance determined as effective in the normal mode in Step 802 in FIG. 8, i.e., the burstable instance in the normal mode determined that the base line is effective to the prediction series 701. The box 901 is displayed at a color concentration that can recognize the performance penalty in the higher series 702 calculated in Step 807 in FIG. 8. In the present embodiment, in the case in which the performance penalty is zero, the color concentration is white, and the color becomes more black as the performance penalty is close to 100%. According to this box 901, the normal cost of the burstable instance having a low base line in the normal mode can be grasped, and the situations of the performance penalty can be grasped, which are due to the incapability of increasing the CPU usage rate to the base line or above in the case in which a necessary CPU usage rate is high.

The box 902 is a box corresponding to the burstable instance determined as effective in the normal mode in Step 808, i.e., the burstable instance in the normal mode determined that the base line is effective to the higher series 702. According to the boxes 901 and 902, the cost of the burstable instance having a low base line can be easily compared with the cost of the burstable instance that is subject to no performance penalty.

The box 903 is a box corresponding to the burstable instance in the unlimited mode determined as effective in Step 802, i.e., the burstable instance in the unlimited mode determined that the base line is effective to the prediction series 701. In the box 903, a cost penalty in the higher series 702 calculated in Step 807 in FIG. 8 is displayed by a hair stroke 905. According to this box 903, the normal cost of the burstable instance having a low base line in the unlimited mode can be grasped, and the cost penalty occurring by increasing the CPU usage rate to the base line or above in the case in which a necessary CPU usage rate is high can be grasped.

The box 904 is a box corresponding to the burstable instance in the unlimited mode determined as effective in Step 808, i.e., the burstable instance in the unlimited mode determined that the base line is effective to the higher series 702. According to the boxes 903 and 904, the cost of the burstable instance having a low base line can be easily compares with the cost of the burstable instance that is subject to no performance penalty, and the cost in the case in which a cost penalty occurs in the burstable instance having a low base line can be easily compared with the cost of the burstable instance that is subject to no performance penalty.

The cost or penalty between the standard mode and the unlimited mode can be easily grasped and compared using the boxes 901, 902, 903, and 904.

On the burstable instance recommendation screen 407, a line 906 expressing the cost in the case in which the on-premise instance that is a migration target is migrated to a migratable fixed performance instance is displayed. According to the line 906, the cost in the case in which the migration destination is the fixed performance instance can be easily compared with the cost in the case in which the migration destination is the burstable instance, and it can be determined that which instance is appropriate.

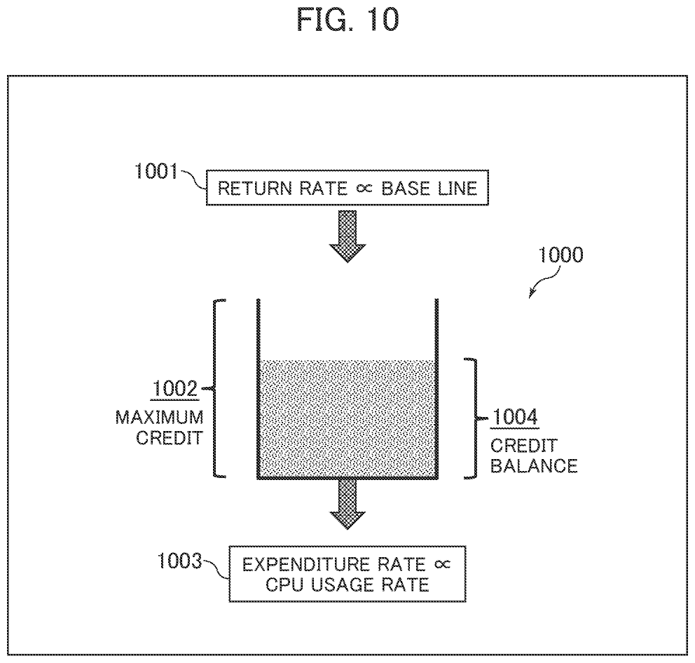

FIG. 10 is a diagram illustrating the management of a CPU credit according to an embodiment.

A CPU credit bucket 1000 manages the CPU credit allocated to the burstable instance. In the case in which the balance of the CPU credit (CPU credit balance) 1004 is present in the CPU credit bucket 1000, a user can use the CPU at a burstable usage rate in the burstable instance with no additional cost, i.e., at a usage rate exceeding the base line. To the CPU credit bucket 1000, a maximum credit 1002 of the CPU credit that can be accumulated. Therefore, the CPU credit bucket 1000 is not allowed to accumulate a CPU credit exceeding the maximum credit 1002. The maximum credit 1002 is set by a public cloud vender providing burstable instances, for example.

The CPU credit can be accumulated in the CPU credit bucket 1000 according to a return rate proportional to the base line, while the CPU credit is consumed according to an expenditure rate proportional to the CPU usage rate.

Next, a change in the CPU usage rate and a change in the CPU credit balance will be described.

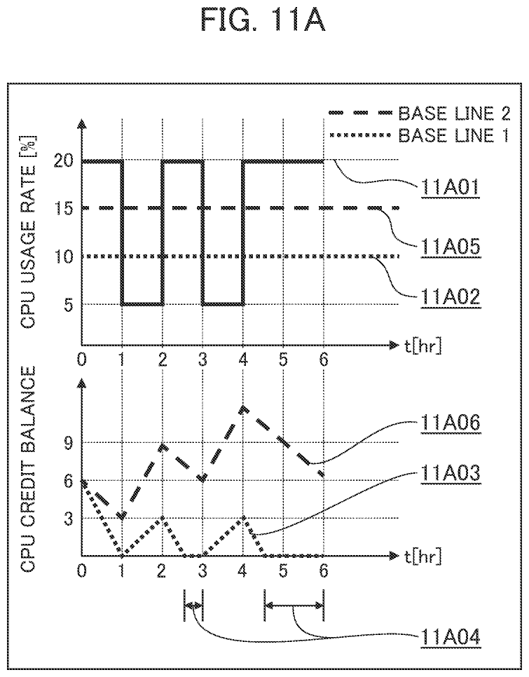

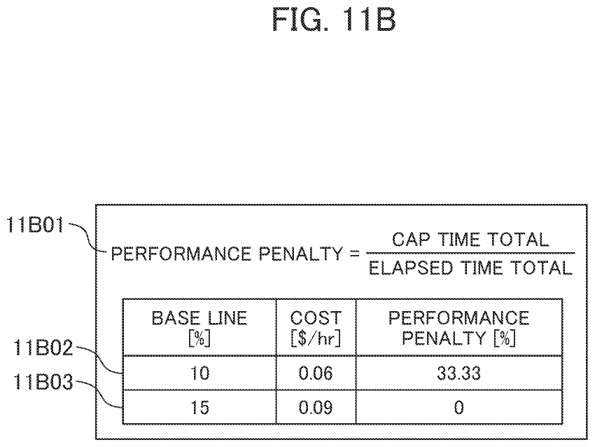

FIG. 11A is a diagram illustrating examples of a change in the CPU usage rate and a change in the CPU credit balance according to an embodiment. In FIG. 11A, a graph on the upper side expresses a change in the CPU usage rate requested to a lapse of time, and a graph on the lower side expresses a change in the CPU credit balance of different burstable instances having different base lines in the case in which a change is observed in the CPU usage rate shown in the graph on the upper side.

On the graph on the lower side, a change in the CPU credit balance of the burstable instance having a 10% base line is expressed by line 11A03, and a change in the CPU credit balance of the burstable instance having a 15% base line is expressed by line 11A06. Here, the CPU credit balances of the burstable instances at time 0 is six.

First, a change in the CPU credit balance of the burstable instance having a 10% base line will be described.

The CPU usage rate is 20% at time 0 to time 1 exceeding the base line, and thus the CPU credit balance is decreased. The CPU usage rate is 5% at time 1 to time 2, and the CPU usage rate is below the base line, and thus the CPU credit balance is increased. The CPU usage rate is 20% at time 2 to time 3 exceeding the base line, and thus the CPU credit balance becomes decreased, and thus the CPU credit balance becomes zero. The CPU usage rate is 5% at time 3 to time 4, and the CPU usage rate is below the base line, and thus the CPU credit balance is increased. The CPU usage rate is 20% at time 4 to time 5 exceeding the base line, and thus the CPU credit balance becomes decreased, and the CPU credit balance becomes zero. The CPU usage rate is 20% at time 5 to time 6 exceeding the base line, and thus the CPU credit balance remains zero. Here, in regard to the CPU credit balance of the burstable instance having a 10% base line, the CPU credit balance is zero at time 11A04. In this case, when the burstable instance is in the normal mode, to use the CPU usage rate is restricted so as not to exceed the base line or above, i.e., the performance penalty occurs. On the other hand, when the burstable instance is in the unlimited mode, the cost penalty occurs.

Subsequently, a change in the CPU credit balance of the burstable instance having a 15% base line will be described.

The CPU usage rate is 20% at time 0 to time 1 exceeding the base line, and thus the CPU credit balance is decreased. Note that since the return rate of the CPU credit is larger as the base line is larger, the amount of a decrease in the CPU credit is smaller than the instance having a 10% base line. The CPU usage rate is 5% at time 1 to time 2, and the CPU usage rate is below the base line, and thus the CPU credit balance is increased. As described above, since the return rate of the CPU credit is larger as the base line is larger, the amount of an increase in the CPU credit is larger than the instance having a 10% base line. The CPU usage rate is 20% at time 2 to time 3 exceeding the base line, and thus the CPU credit balance does not become zero although the CPU credit balance becomes decreased. The CPU usage rate is 5% at time 3 to time 4, and the CPU usage rate is below the base line, and thus the CPU credit balance is increased. The CPU usage rate is 20% at time 4 to time 5 exceeding the base line, and thus the CPU credit balance becomes decreased. The CPU usage rate is 20% at time 5 to time 6 exceeding the base line, and thus the CPU credit balance decant become zero although the CPU credit balance becomes decreased.

Next, an example calculation method for a performance penalty in Step 807 in FIG. 8 in the situations shown in FIG. 11A will be described.

FIG. 11B is a diagram illustrating an example calculation method for performance penalties according to an embodiment.

As shown in equation 11B01, the performance penalty may be calculated in which the total of time (CAP time total) for which the CPU usage rate is restricted to the base line in a period from a predetermined point in time, for example, is divided by the total of elapsed time from a predetermined point in time (elapsed time total), or a unit may be percentage.

In the situations shown in FIG. 11A, to the burstable instances in Step 807, the burstable instance recommendation program 2054 calculates the performance penalty as 33.33% to the burstable instance having a 10% base line as shown in a record 11B02, and calculates the performance penalty as 0% to the burstable instance having a 15% base line as shown in a record 11B03. Note that the performance penalties calculated in these manners are recognizably displayed on the burstable instance recommendation screen 407.

For example, it can be grasped that in the case in which the performance penalty is not desired, a burstable instance having a base line exceeding 15% only has to be selected as a burstable instance for a migration destination.

Note that the present invention is not limited to the foregoing embodiment, and can be appropriately modified for implementation within the scope not deviating from the gist of the present invention.

For example, in the embodiment, the prediction series 701 is estimated from the history time series data, and the higher series 702 is identified. However, the present invention is not limited to this, and may be configured as below. That is, a configuration may be provided in which history time series data itself is used instead of the prediction series 701, and time series data higher by a predetermined error range (e.g. 5%) to history time series data is used instead of the higher series 702. In this case, time series data higher than history time series data may be generated instead of Step 603, and the process in Step 604 only has to be omitted. Thus, loads for necessary processes can be decreased.

What is claimed is:

1. A burstable instance recommendation apparatus comprising a processor, the burstable instance recommendation apparatus providing information on a burstable instance provided by a public cloud, the burstable instance being a candidate to which a predetermined instance under utilization is migrated,
wherein: the processor identifies a first candidate burstable instance provided by the public cloud, the first candidate burstable instance to which the instance under utilization is migratable based on performance time series data of the instance under utilization, the processor calculates high load performance time series data in which occurrence of a load higher than in the performance time series data is estimated on the identified first candidate burstable instance, and the processor calculates a penalty in case of the high load performance time series data; and
the processor recognizably displays a cost of the first candidate burstable instance and the penalty.

2. The burstable instance recommendation apparatus according to claim 1,
wherein the processor calculates prediction performance time series data in which future performance time series data is estimated based on the performance time series data, and the processor sets burstable instance satisfying the prediction performance time series data to the first candidate burstable instance.

3. The burstable instance recommendation apparatus according to claim 2,
wherein the processor calculates the high load performance time series data based on the prediction performance time series data.

4. The burstable instance recommendation apparatus according to claim 1,
wherein: the processor identifies second candidate burstable instance satisfying the high load performance time series data; and
the processor recognizably displays a cost of the second candidate burstable instance.

5. The burstable instance recommendation apparatus according to claim 1,
wherein the penalty is a cost penalty or a performance penalty, the cost penalty in which a performance is providable exceeding a reference performance by the candidate burstable instance when a predetermined condition is satisfied, the cost penalty due to provision of a performance exceeding the reference performance in case of a mode in which a performance is providable exceeding the reference performance by the cost penalty even when the predetermined condition is not satisfied, the performance penalty in which a performance is providable exceeding a reference performance when a predetermined condition is satisfied, the performance penalty due to no provision of a performance exceeding the reference performance in a case of a mode in which no performance is providable exceeding the reference performance even when the predetermined condition is not satisfied.

6. The burstable instance recommendation apparatus according to claim 2,
wherein: the processor determines effectiveness of a prediction model estimating the prediction performance time series data of the instance under utilization; and
the processor sets an instance under utilization from which prediction performance time series data is obtained, the prediction performance time series data being estimated by a prediction model having effectiveness with a predetermined criteria or more, to a target identifying the first candidate burstable instance.

7. A burstable instance recommendation method using a burstable instance recommendation apparatus providing information on a burstable instance provided by a public cloud, the burstable instance being a candidate to which a predetermined instance under utilization is migrated,
wherein: the burstable instance recommendation apparatus identifies a first candidate burstable instance provided by the public cloud, the first candidate burstable instance to which the instance under utilization is migratable based on performance time series data of the instance under utilization, the burstable instance recommendation apparatus calculates high load performance time series data in which occurrence of a load higher than in the performance time series data is estimated on the identified first candidate burstable instance, and the burstable instance recommendation apparatus calculates a penalty in case of the high load performance time series data; and
the burstable instance recommendation apparatus recognizably displays a basic cost of the first candidate burstable instance and the penalty.

8. The burstable instance recommendation method according to claim 7,
wherein the burstable instance recommendation apparatus calculates prediction performance time series data in which future performance time series data is estimated based on the performance time series data, and the burstable instance recommendation apparatus sets burstable instance satisfying the prediction performance time series data to the first candidate burstable instance.

9. The burstable instance recommendation method according to claim 8,
wherein the burstable instance recommendation apparatus calculates the high load performance time series data based on the prediction performance time series data.

10. The burstable instance recommendation method according to claim 7,
wherein the burstable instance recommendation apparatus identifies second candidate burstable instance satisfying the high load performance time series data; and
the burstable instance recommendation apparatus recognizably displays a cost of the second candidate burstable instance.

11. A burstable instance recommendation program causing a computer to execute providing information on a burstable instance provided by a public cloud, the burstable instance being a candidate to which a predetermined instance under utilization is migrated,
wherein the burstable instance recommendation program causes the computer to:
identify a first candidate burstable instance provided by the public cloud, the first candidate burstable instance to which the instance under utilization is migratable based on performance time series data of the instance under utilization, to calculate high load performance time series data in which occurrence of a load higher than in the performance time series data is estimated on the identified first candidate burstable instance, and to calculate a penalty in case of the high load performance time series data; and
to recognizably display a cost of the first candidate burstable instance and the penalty.
